(19) United States
(12) Patent Application Publication
(10) Pub. No.: US 2006/0015410 A1
(43) Pub. Date: Jan. 19, 2006

(54) Information registering method, information managing apparatus and advertisement displaying system

(76) Inventors: Hirofumi Nagano, Yokohama (JP); Jun Maeoka, Yokohama (JP); Shinya Iguchi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/087,622

(22) Filed: Mar. 24, 2005

(30) Foreign Application Priority Data
Jul. 14, 2004 (JP) 2004-207542

(51) Int. Cl. G06Q 30/00

(52) U.S. Cl. 705/26; 705/14

(57) ABSTRACT

A terminal notifies a server of a processing method of contents, the server notifies the terminal of an E-mail address associated with the processing method notified to the server, the terminal transmits the contents to the E-mail address in the server that the terminal is notified, the server receives the contents transmitted to the E-mail address, and processes the contents based on the processing method thus notified.

### CLAIM OF PRIORITY

The present application claims priority from Japanese application serial No. 2004-207542 filed on Jul. 14, 2004, the content of which is hereby incorporated by reference into this application.

### BACKGROUND OF THE INVENTION

The present invention relates to a method to register information into a server that manages information from a terminal connected to a network. More particularly, it relates to an information registering method, which registers contents and processing methods associated therewith, independently of each other, and an information managing apparatus and an advertisement displaying system which employ the above information registering method.

When contents are registered into a server via the Internet, it is common practice to register both the contents and processing methods associated therewith all at once by use of a browser. When the information to be registered is a file such as an image, there is employed a method which loads the file held locally and transmits thus loaded file.

In such a commonly used contents registering method via the Internet as described above, it is necessary to register the contents and the processing methods associated therewith all at once. Therefore, there has been a problem that if a local file system is not accessible, the contents are not allowed to be registered. For example, since a local file system is not accessible from a browser installed on a mobile telephone due to a security problem, a local file has not been allowed to be loaded and transmitted. In the case where information is registered from a public terminal and the like, local information is not allowed to be loaded either. Therefore, a file such as image data owned by an individual has not been registrable. More particularly, when the information is to be updated, it is necessary to load all the information from the server in order to modify only the parts to be updated, and all the information should be registered once again after the modification. Therefore, it is inconvenient for a user, if he or she frequently updates specific information only. Furthermore, it has not been allowed to share particular contents by multiple processing methods.

Considering the problems above, there have been proposed following two methods, as a way of example, to register contents such as images and processing methods associated therewith, independently of each other. JP-A-2002-189723 discloses a technique in which multiple image data items are uploaded in a server beforehand and when creating contents using these image items, the image data items are browsed and some are selected. In addition, U.S. Pat. No. 6,742,024 (JP-A-2001-142820) discloses a technique in which a command is described as a subject of E-mail, and contents are processed on the basis of the command.

Since it is possible to register multiple images beforehand according to the technique disclosed in JP-A-2002-189723, a user is allowed to select contents in a different occasion and execute processing. However, in this technique, since the user is required to browse and select contents, a registration process has not been easily performed with a portable terminal whose screen is small.

On the other hand, the technique as shown in U.S. Pat. No. 6,742,024 (JP-A-2001-142820) discloses a method for a user to register a process for the contents, by use of an E-mail. However, since it is necessary for the user to input a processing command by oneself, the user is required to have a knowledge regarding the processing command. In addition, there is a possibility of causing a mistake in processing due to a command input error, and thus it may be inconvenient for the user.

### SUMMARY OF THE INVENTION

A first object of the present invention is to provide a method to easily and reliably register information such as image data owned by a user, even when local information on an information registering terminal is inaccessible, and an information managing apparatus and an advertisement displaying system, which utilize the above method.

In order to achieve the first object, according to the present invention, a processing for contents is registered in advance and a unique mail address associated therewith is generated, thereby appropriately relating the processing to the contents. Alternatively, an associating rule is preset between the contents and processing methods, which are accepted from an identical user. In addition, the present invention provides a contents registration method by an E-mail having a specific mail address as a destination address, being a simple registering method that does not require authentication.

The present invention provides an information registering method, which registers contents from an information terminal to an information managing server via a network, including a step in which the information terminal notifies the information managing server of a processing method associated with the contents to be registered, a step in which the information managing server notifies the information terminal of an E-mail address being associated with the processing method thus notified, a step in which the information terminal transmits the contents to the E-mail address thus notified, and a step in which the information managing server receives the contents transmitted to the E-mail address, and processes the contents based on the processing method thus notified.

The present invention further provides an information registering method which registers contents into an information managing server from an information terminal via a network, including a step in which the information terminal transmits a processing method associated with contents to be registered to a predetermined E-mail address, a step in which an (the ?) information terminal transmits the contents to the E-mail address, and a step in which the information managing server processes, based on the processing method being received, the contents whose destination E-mail address corresponds to that of the processing method.

The present invention further provides an information registering method which registers contents into an information managing server from an information terminal via a network, including a step in which the information terminal transmits the contents to the information managing server by use of an E-mail, a step in which the information terminal transmits a processing method for the contents by use of an E-mail, and a step in which the information managing server receives the contents and the processing method thus transmitted, and processes, based on the processing method thus received, the contents whose sending-end E-mail address corresponds to that of the processing method.

The present invention further provides an information managing apparatus and an advertisement displaying system, which use the information registering method according to the present invention as described above.

According to the present invention, it is desirable that the information managing apparatus further includes a means which generates an E-mail address to accept transmitted contents, in such a manner as being associated with the processing method having been notified. Alternatively, the E-mail address may be generated with respect to each user.

If multiple contents exist as processing targets, it may be possible to decide which contents is to be processed based on at least any of transmitting/receiving (registering) time of the contents and/or a processing method, and a receiving order. It may be possible to decide by associating the contents with the processing method, having the closest points of receiving time to each other, for instance. In addition, according to the present invention, it may also be possible to give identifiers to the contents and the processing methods thus received respectively, and to accept a designation of the contents to be processed and/or processing method according to the identifiers.

According to the present invention, it is possible for a user to register contents and processing methods associated therewith, independently of each other. Furthermore, according to the present invention, it is possible to easily update the contents such as an image, by use of an E-mail.

### BRIEF DESCRIPTION OF THE DRAWINGS

FIG. 1 shows a total configuration of an advertisement displaying system.

FIG. 2 shows an internal structure of a portable terminal held by a user.

FIG. 3 shows an internal structure of the advertisement displaying system.

FIG. 4 shows a processing flow in the case where an advertisement displaying method is registered.

FIG. 5 shows a screen layout of a user registration screen.

FIG. 6 shows a data structure of user information DB.

FIG. 7 shows a screen layout of an advertisement displaying method registration screen.

FIG. 8 shows a data structure of advertisement displaying method DB.

FIG. 9 shows a processing flow in the case where advertisement image information is registered.

FIG. 10 shows a data structure of advertisement image information DB.

FIG. 11 shows a processing flow in the case where an advertisement management server has received advertisement information.

FIG. 12 shows a processing flow of an advertisement displaying apparatus which has received advertisement information.

FIG. 13 shows an advertisement screen layout of the advertisement displaying apparatus.

FIG. 14 shows a processing flow to register the advertisement displaying method, in a case where a unique mail address is set to the advertisement displaying method as described in the second embodiment.

FIG. 15 shows a data structure of the advertisement displaying method DB, in a case where a unique mail address is set to the advertisement displaying method as described in the second embodiment.

FIG. 16 shows a processing flow to register the advertisement image information, in a case where a unique mail address is set to the advertisement displaying method as described in the second embodiment.

FIG. 17 shows a data structure of the advertisement image information DB, in a case where a unique mail address is set to the advertisement displaying method as described in the second embodiment.

### DETAILED DESCRIPTION OF THE PREFERRED EMBODIMENTS OF THE INVENTION

Preferred embodiments of the present invention will be specifically explained by taking as a way of example, an advertisement information registering method in an advertisement displaying system. However, the present invention is not limited to this example.

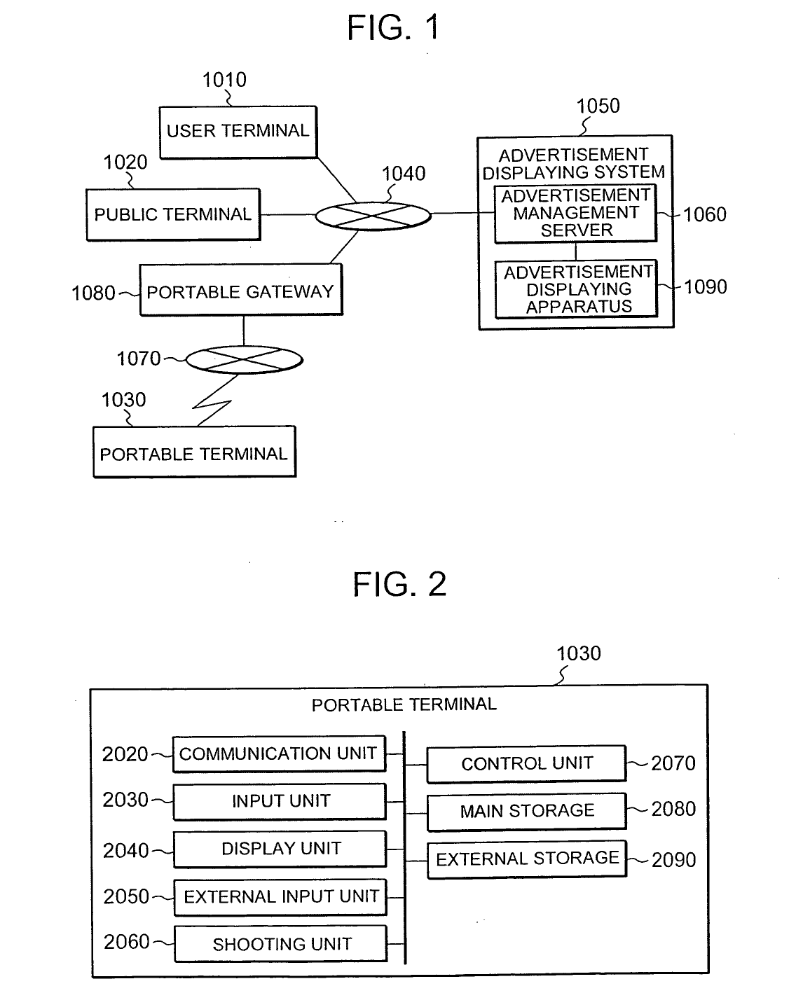

FIG. 1 shows a total configuration of the advertisement displaying system according to the present embodiment. A user utilizes a user terminal 1010 held at home of one's own or the like, a public terminal 1020 installed in a public place, a portable terminal 1030 or the like (a first information processing unit), to establish connection with an advertisement managing server 1060 in the advertisement displaying system 1050 (a second information processing unit), via the Internet 1040. The portable terminal is connected to the advertisement management server via a portable gateway 1080 which mediates the portable network 1070 and the Internet.

FIG. 2 shows an internal structure of the portable terminal. The portable terminal 1030 includes a communication unit 2020 to establish connection with the Internet via the portable gateway, an input unit 2030 through which the user inputs information, a display unit 2040, an external input unit 2050 which is used to input a file such as an image from the outside, a shooting unit 2060 to capture an advertisement image and the like, a control unit 2070 to carry out various processing, a main storage 2080, and an external storage 2090 to store information such as an image.

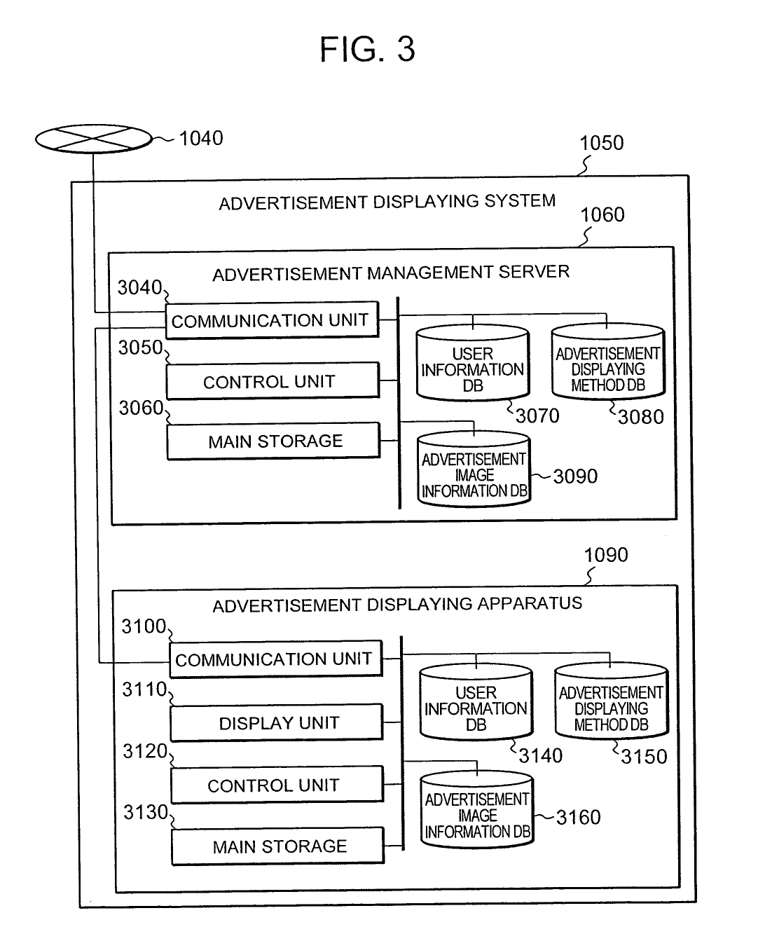

FIG. 3 shows an internal configuration of the advertisement displaying system. The advertisement displaying system 1050 includes the advertisement management server 1060 and an advertisement displaying apparatus 1090. The advertisement management server includes a communication unit 3040 to establish communication with a user terminal and/or the advisement displaying apparatus, a control unit 3050 to carry out various processing, a main storage 3060, a user information database (hereinafter, abbreviated as “DB”) 3070, which stores attribute information of the user, an advertisement displaying method DB 3080 to store an advertisement displaying method, and an advertisement image information DB 3090 to store an advertisement image file.

The advertisement displaying apparatus is connected to the advertisement management server via a local network such as LAN (Local Area Network) and the like, and receives advertisement information and the like as appropriate to display advertisement. The advertisement displaying apparatus includes a communication unit 3100 to establish communication with the advertisement management server, a display unit 3110 to display the advertisement information, a control unit 3120 to perform a display control and the like, a main storage 3130, a user information DB 3140 which stores the user information, an advertisement displaying method DB 3150 which stores an advertisement displaying method, and an advertisement image information DB 3160 which stores the advertisement information, each transmitted from the advertisement management server respectively.

The advertisement management server and the advertisement displaying apparatus are connected to the Internet 1040, respectively through communication units of their own.

By utilizing the user terminal, public terminal, or portable terminal, the user is allowed to register multiple information items in the advertisement management server, such as user registration information, advertisement displaying method, advertisement image information, respectively in different occasions. The advertisement management server, which has accepted these information items, appropriately associates the information items registered in each occasion with one another. After the information items necessary for advertisement information are prepared, the advertisement management server performs a control to display the advertisement on the display unit.

Hereinafter, according to the present embodiment, there will be explained an example in which a user registers advertisement text information from a browser on a portable terminal, and in another occasion, the user registers advertisement image information from the same portable terminal via an E-mail, and then, the two information items are associated with each other by an E-mail address (in some cases, it is referred to just as “mail address” in the present specification), which has been registered at the time of user registration. According to the present embodiment, there will be explained an example in which only the portable terminal is used as a medium for a user to register information. However, different information terminals may be used for registering each information item, and in any of such cases, the same procedure as the following will be taken. It is preferable that the advertisement managing server allocates an E-mail address with respect to each user and each processing method (for example, advertisement displaying method). However, it may also be possible to allocate an E-mail address by user, or by processing method. In addition, the advertisement management server may automatically allocate an E-mail address. Alternatively, a user may designate an E-mail address in the advertisement management server via the user terminal.

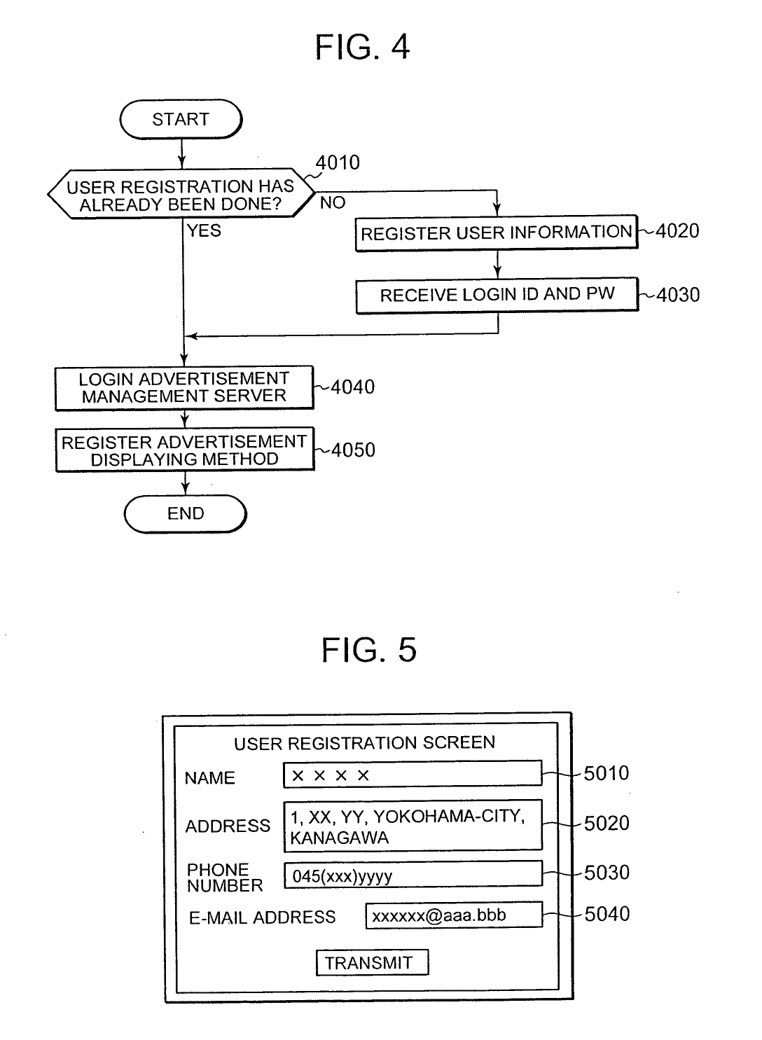

FIG. 4 is a processing flow in the case where a user registers an advertisement displaying time zone and the like as an advertisement displaying method. Firstly, in step 4010, a user executes user registration, if it has not been performed yet. FIG. 5 shows a screen layout of the user registration which is displayed at the time of user registration. In the user registration, a user name 5010, address 5020, phone number 5030, and E-mail address 5040 are registered. The advertisement management server which has received the information items above generates a login identifier (abbreviated as “ID” in the following) and a password (abbreviated as “PW” in the drawings in some cases) of the user, and registers the login identifier and the password thus generated in the user information DB. If the advertisement displaying method relates to a displaying time zone, displaying period of time, or displaying place (displaying area), the advertisement displaying method may be categorized as a displaying condition for advertisement (displaying rule). If the advertisement displaying method relates to a compression, trimming, resizing, color conversion, and encryption/decryption of an advertisement image, the advertisement displaying method may be categorized as a manipulating condition for advertisement image (manipulating rule). If the advertisement displaying method relates to a transfer of the advertisement image, the advertisement displaying method may be categorized as a processing condition for advertisement image (processing rule).

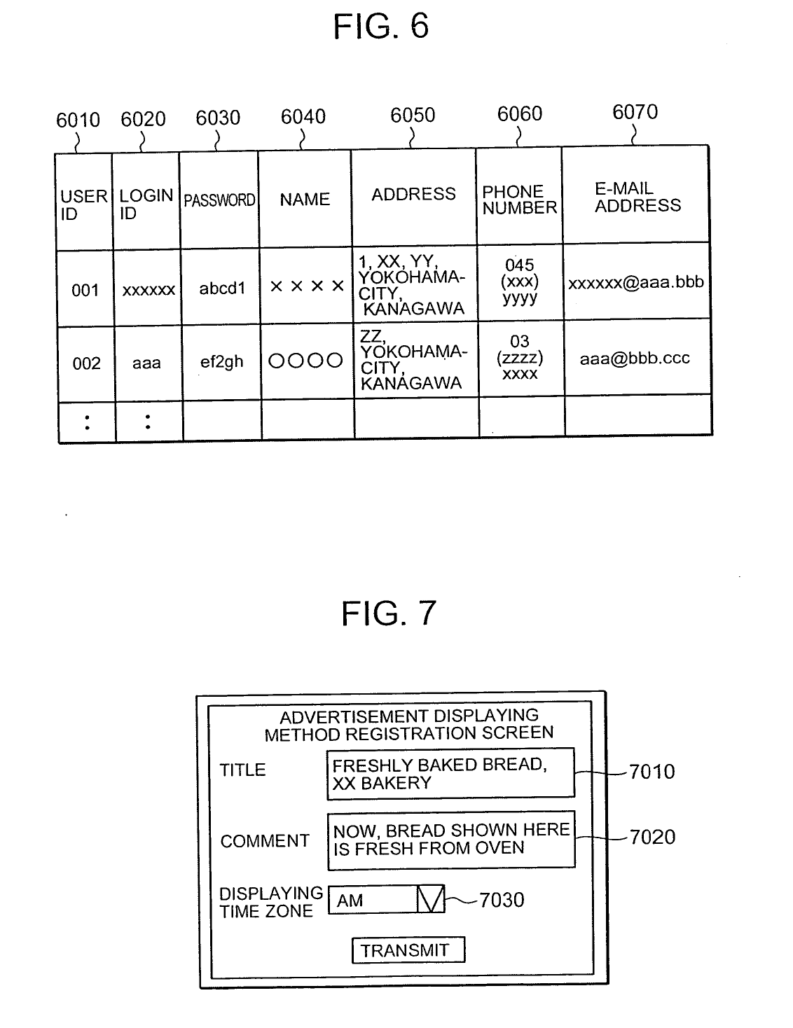

FIG. 6 shows a data structure of the user information DB in the advertisement management server. The user information DB includes user ID 6010, login ID 6020, password 6030, name 6040, address 6050, phone number 6060, and E-mail address 6070.

Returning to FIG. 4, in step 4030, the user receives the login ID and the password from the advertisement management server by way of a portable terminal 1030, and in step 4040, the user logs in the advertisement management server with thus received information items, and registers the advertisement displaying method in step 4050.

FIG. 7 shows a screen layout of a registration screen of the advertisement displaying method. The registration screen of the advertisement displaying method accepts advertisement title 7010, comment 7020, and advertisement displaying time zone 7030. As for the displaying time zone, it is accepted by selecting from a pull-down menu including items such as AM, PM, and ALL DAY.

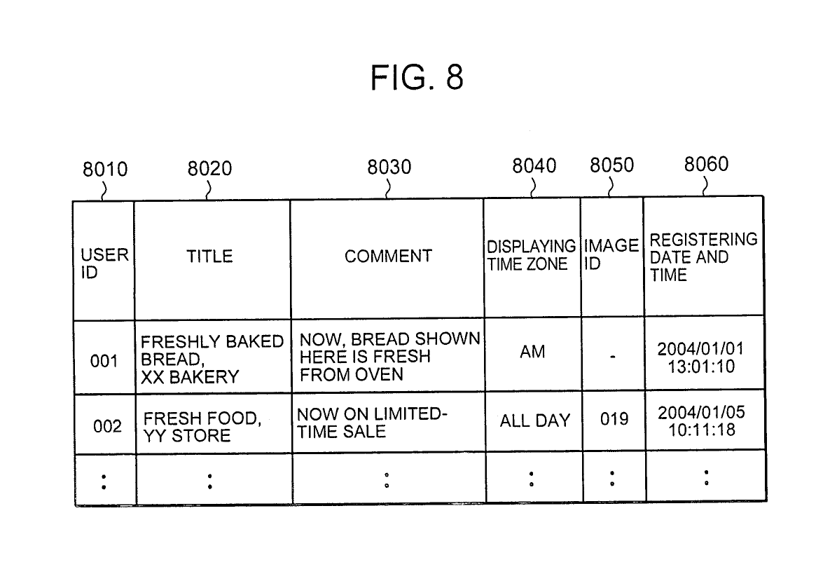

FIG. 8 shows a data structure of the advertisement displaying method DB in the advertisement management server. The advertisement displaying method DB includes user ID 8010, title 8020, comment 8030, displaying time zone 8040, image ID 8050, and registered date and time 8060.

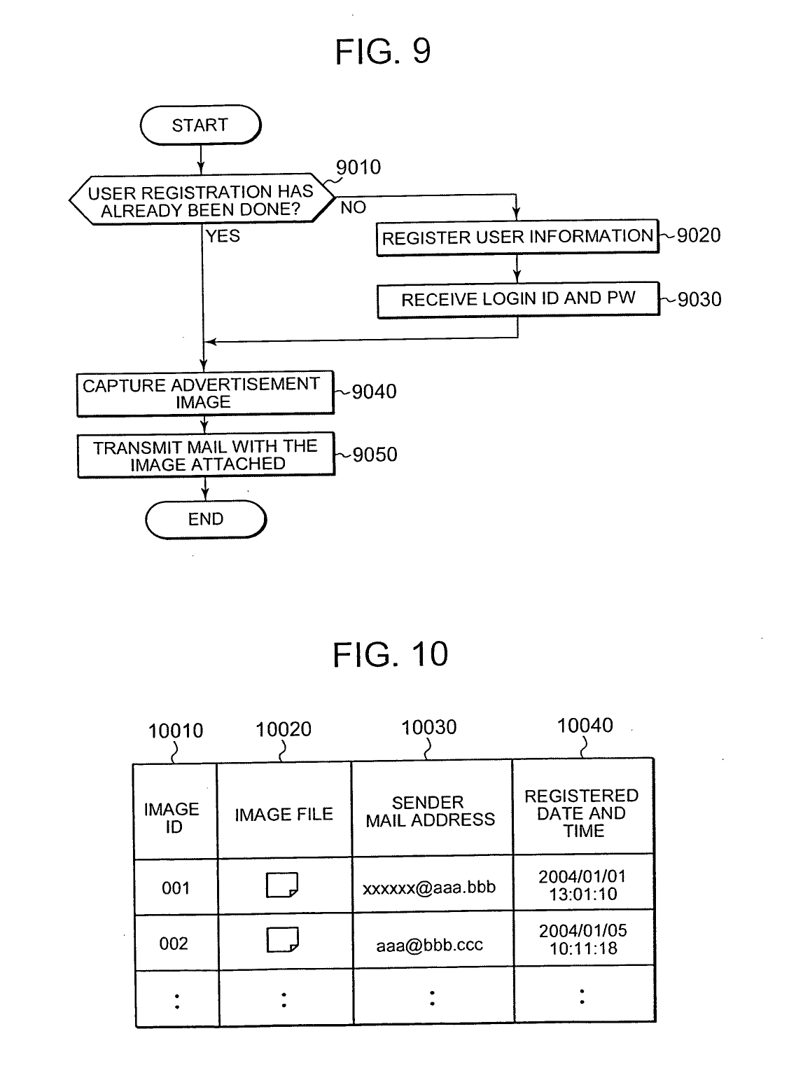

Next, FIG. 9 shows a processing flow in the case where an advertisement image is registered. Similar to the case of registering the advertisement displaying method, if the user registration has not been performed yet in step 9010, it is registered in step 9020. Then, in step 9030, login ID and password are received. Next, in step 9040, an advertisement image is captured by use of the shooting unit of the portable terminal, and a mail with the advertisement image being attached is transmitted to the advertisement management server in step 9050.

FIG. 10 shows a data structure of the advertisement image information DB in the advertisement management server. The advertisement image information includes image ID 10010, image file 10020, sender mail address 10030, and registered date and time 10040.

In the present embodiment, the portable terminal is equipped with the shooting unit, and the advertisement image is captured by this shooting unit. However, another method is also possible, in which an already-captured image is selected, or an image file that has already been captured is read in by using an external input device of the portable terminal, and then, thus captured image is transmitted via an E-mail.

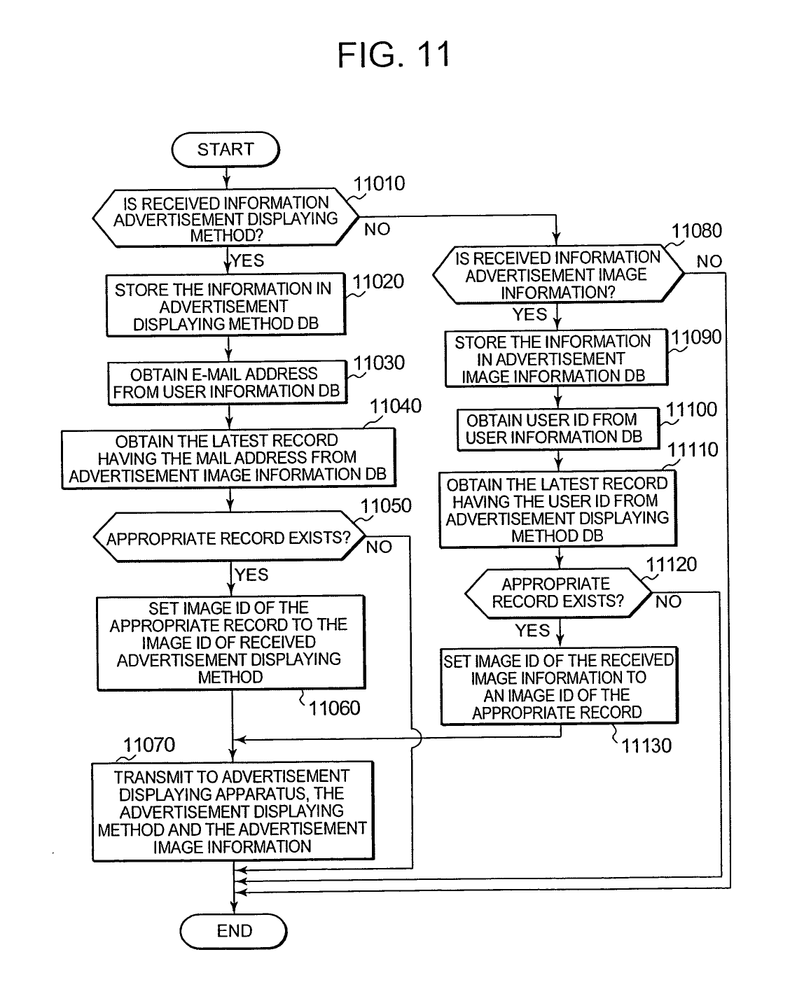

FIG. 11 shows a processing flow in the case where the advertisement management server receives from the user, the advertisement displaying method or the advertisement image information. In step 11010, if the information accepted from the user is the advertisement displaying method, it is registered in the advertisement displaying method DB in step 11020. And then, in step 11030, the user information DB is referred to, using the user ID as a key, and an E-mail address of the user is obtained. Next, in step 11040, the advertisement image information DB is referred to, using the E-mail address as a key, and the latest advertisement image information is obtained. If an appropriate record is not found in step 11050, the processing is completed. When an appropriate record is found, the image ID of the record is set as an image ID of the advertisement displaying method thus received, and in step 11070, the advertisement displaying method and the advertisement image information are transmitted to the advertisement displaying apparatus.

On the other hand, in step 11080, if the received information is advertisement image information, it is registered in the advertisement image information DB in step 11090, and then, in step 11100, the user information DB is referred to, using the sender mail address as a key, and the user ID of the user is obtained. Next, in step 11110, the advertisement displaying method DB is referred to, using the user ID as a key, and the latest advertisement displaying method is obtained. If an appropriate record is not found in step 11120, a process is completed. When an appropriate record is found, the image ID of the advertisement image information thus received is set as an image ID of the record and in step 11070, the advertisement displaying method and the advertisement image information are transmitted to the advertisement displaying apparatus.

After the processing in step 11070, the advertisement display apparatus which received the advertisement displaying method and the advertisement image information, displays the advertisement.

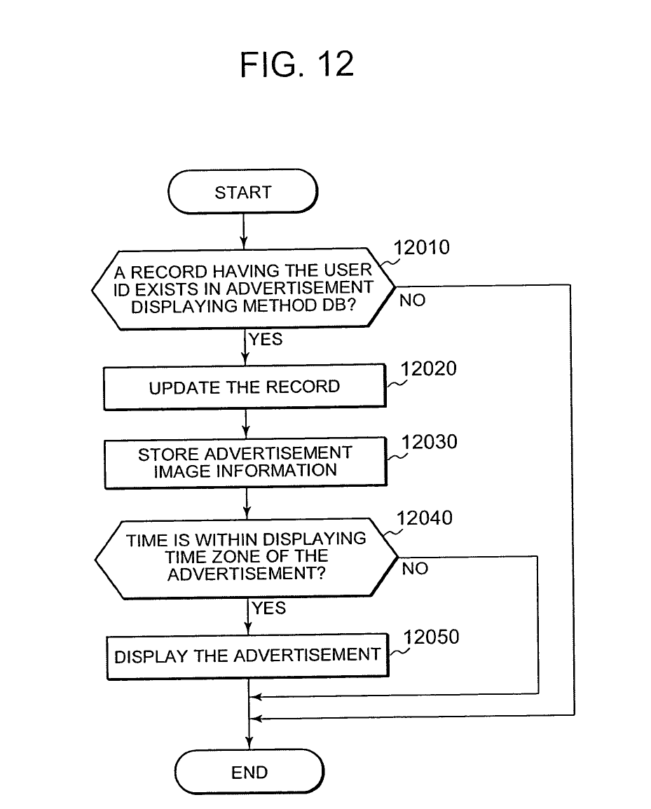

FIG. 12 shows a processing flow of the advertisement displaying apparatus which has received the advertisement information. The advertisement displaying apparatus, which has received the advertisement information from the advertisement management server, refers to the advertisement displaying method DB in step 11030. If there is a record having the user ID of thus received advertisement displaying method, the advertisement displaying apparatus updates the record with the advertisement displaying method thus received, in step 12020. Next, in step 12030, the advertisement displaying apparatus stores the advertisement image information thus received in the advertisement image information DB. Next, in step 12040, it is determined whether or not the time is within the displaying time zone of the advertisement. If it is within the displaying time zone, the advertisement is displayed in step 12050.

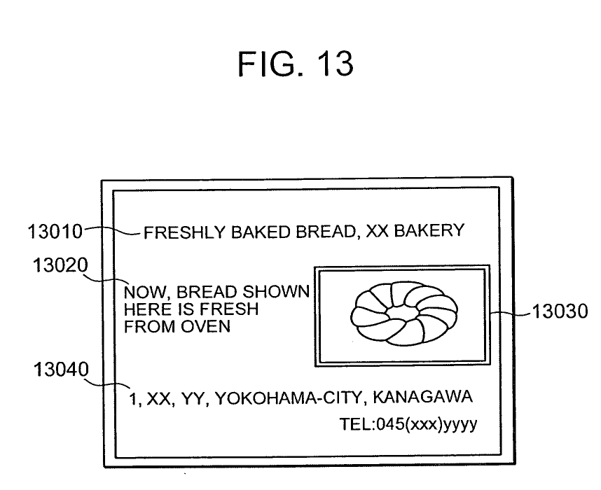

FIG. 13 shows a screen layout of the advertisement displaying screen of the advertisement displaying apparatus. In the advertisement displaying screen, there are displayed, advertisement title 13010 and advertisement comment 13020 from the advertisement displaying method DB, advertisement image 13030 from the advertisement image information DB, and user address (store address), user phone number (store phone number) 13040 and the like from the user information, which is updated every time when the user registration is conducted. According to the above series of processing, so long as a mail address is previously registered at the time of user registration, it is possible to associate the latest advertisement displaying method with the latest advertisement image, whereby the advertisement contents are allowed to be registered independently at arbitrary points of time.

By transmitting a mail together with an image being attached therewith, for example, by use of a camera-equipped portable terminal, it is further possible to frequently update only the advertisement image. Alternatively, by accessing the advertisement management server through a browser of the portable terminal and transmitting the advertisement comment as an advertisement displaying method, it is possible to frequently update only the advertisement comment.

In the present embodiment, there has been explained a way for relating the latest advertisement displaying method to the latest advertisement image. However, in step 11110 as shown in FIG. 11, if the latest record having the user's ID and to which an image ID has not been registered yet is obtained from the advertisement displaying method DB, and if the image ID being recorded is utilized as a flag indicating that the user's ID record has already been treated, it is possible to establish one-to-one correspondence between the advertisement image and the advertisement displaying method.

In the above embodiment, an E-mail address registered at the time of user registration is used as information to associate the advertisement displaying method with the image information. However, it is further possible to register this E-mail address as a part of the advertisement displaying method, not registered at the time of user registration. With this method, different E-mail addresses are registered respectively for the advertisement displaying methods being registered, and independent advertisement images are registered respectively from the different E-mail addresses, thereby one identical user is capable of registering multiple advertisements.

In the above embodiment, a mail address is registered at the time of user registration, and the mail address allows an advertisement image to be associated with an advertisement displaying method. There is an alternative method in which the advertisement management server may allocate a user a unique mail address at the time of user registration, and the user transmits an advertisement image to the mail address. In this case, in the user information DB as shown in FIG. 6, an E-mail address, which has been allocated by the advertisement management server, is registered as E-mail address 6070, and a destination mail address is registered instead of the sender mail address in the advertisement image DB as shown in FIG. 10. By use of the mail addresses in the two databases, a user who registered each record in the advertisement displaying method DB is identified, thereby allowing the advertisement displaying method to be associated with the advertisement image, according to the same method as described in the above embodiment.

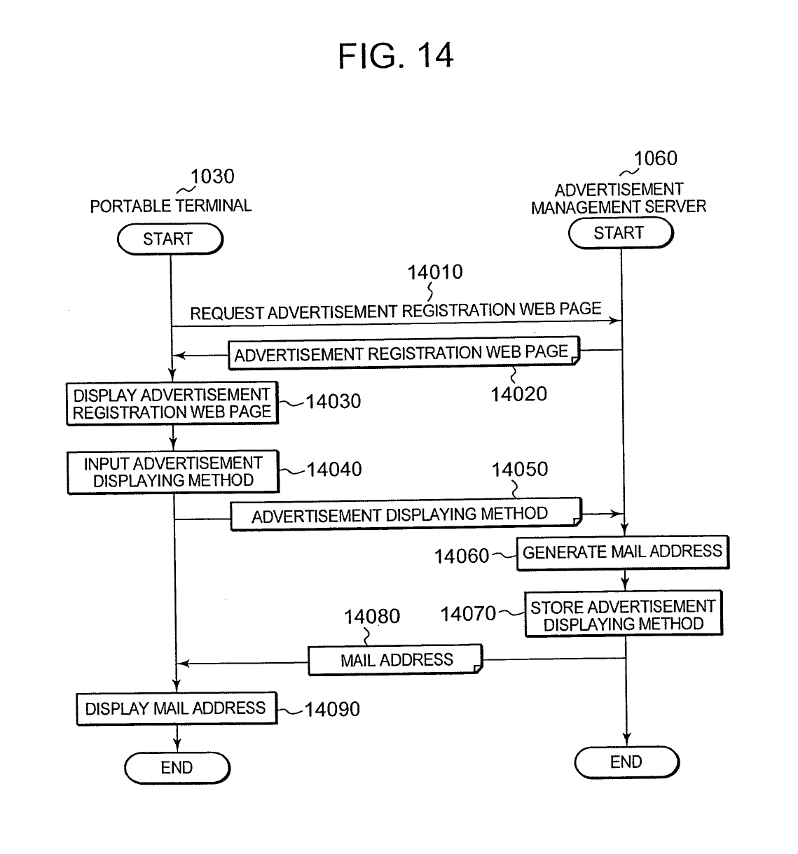

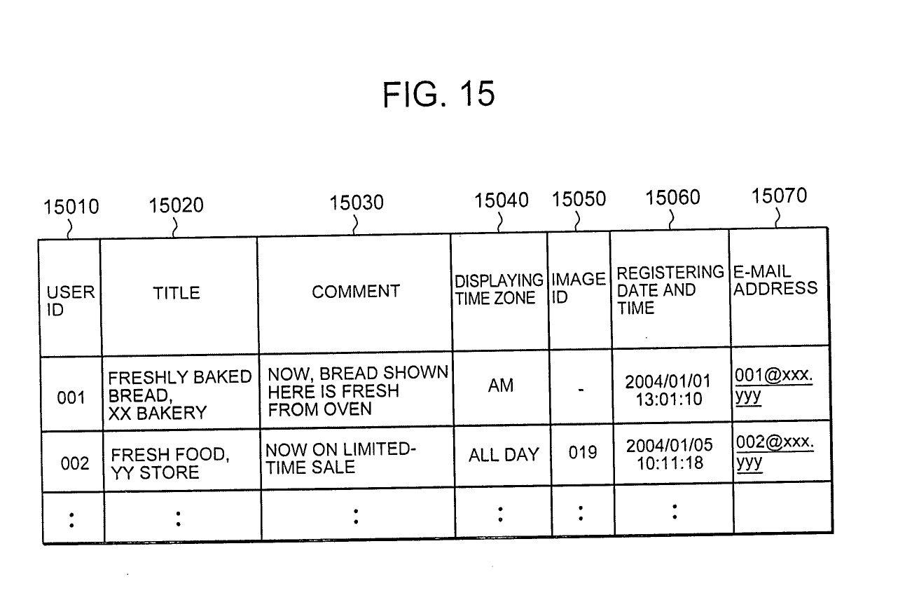

There may be another method in which at the time when an advertisement displaying method is accepted from the user, a unique mail address for the advertisement displaying method is generated and transmitted to the user, and the advertisement image transmitted to the mail address is displayed by the above displaying method. Referring to FIG. 14 to FIG. 17, an embodiment in which the above method is utilized will be explained. It is to be noted that a system configuration in the present embodiment is the same as that of the first embodiment as shown in FIG. 1 to FIG. 3, and a processing flow is also the same except those described in the following.

FIG. 14 shows an entire flow of the advertisement registration method according to the present embodiment. Since the user registration is not absolutely necessary in the present embodiment, flows for user authentication and user registration are not described, but generally, the user registration and the user authentication are carried out for preventing registration of unauthorized contents.

At first, the portable terminal 1030 transmits an advertisement registration Web page request 14010 to the information registration server in response to an input of directive from a user, and displays thus received advertisement registration Web page 14020 in step 14030 (FIG. 14). A screen displayed at this stage is exactly shown in FIG. 7, and it is possible to accept inputs of a title of the advertisement, a comment, and a displaying time. Next in step 14040, the portable terminal 1030 transmits the advertisement displaying method 14050 inputted by the user to the advertisement management server.

The advertisement management server 1060 which received the advertisement displaying method generates a unique mail address for the advertisement displaying method in step 14060, and in step 14070, the advertisement management server stores thus received advertisement displaying method and the mail address in the advertisement displaying method DB.

FIG. 15 shows a data structure of the advertisement displaying method DB. The advertisement displaying method DB in the present embodiment stores in step 14060 E-mail address 15070 generated as well as advertisement displaying method ID 15010, title 15020, comment 15030, displaying time zone 15040, image ID 15050, registered date and time 15060. For example, by use of the advertisement displaying method ID, it is possible to generate the E-mail address in a form of (advertisement displaying method ID) @xxx.yyy.

Now, returning to FIG. 14, after storing the advertisement displaying method in the advertisement displaying method DB in step 14070, the advertisement management server 1060 transmits thus generated mail address 14080. The portable terminal 1030 which has received the mail address displays thus received mail address in step 14090.

As for the mail address displayed in the portable terminal 1030, it is possible for a user to immediately shift to a mail creating screen by clicking the address. Alternatively, it is possible to register the address in an address book function of the portable terminal, thereby facilitating a shift to the mail creating screen with a simple operation, if a mail is created at a later date.

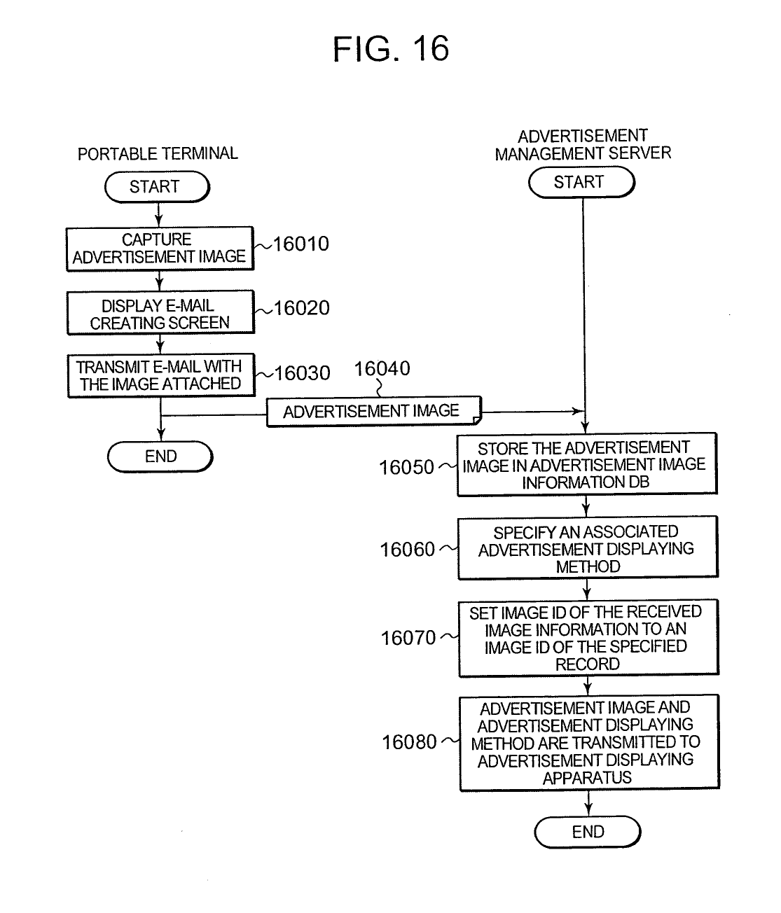

FIG. 16 shows a processing flow in the case where an advertisement image is registered in the advertisement management server, by use of the mail address obtained in such a manner as described above.

In the example employed here, a user captures an advertisement image through the use of the shooting unit equipped on the portable terminal in step 16010. Next, in step 16020, according to the method as described above, the E-mail creating screen having a destination of the E-mail address that has been received in step 14090 in FIG. 14 is displayed on the portable terminal.

Next, the above advertisement image 16040 is attached to an E-mail in step 16030 and then it is transmitted. In step 16050, the advertisement management server which has received the E-mail, stores the advertisement image and a destination mail address having been received, in the advertisement image information DB, and in step 16060, the advertisement management server refers to the advertisement displaying method DB using the destination of the E-mail as a key, and searches for an associated advertisement displaying method.

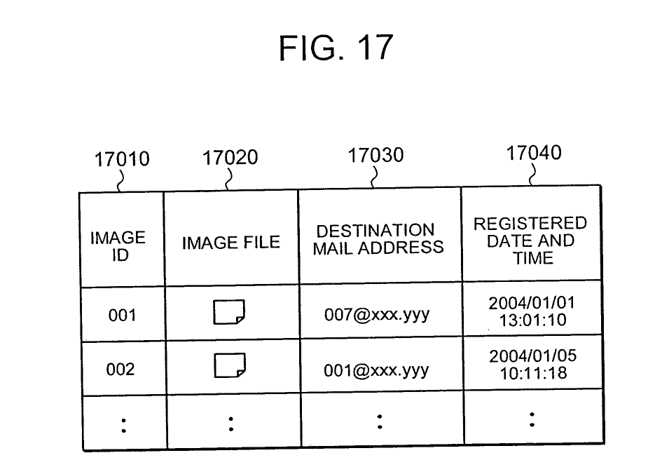

FIG. 17 shows a data structure of the advertisement image information DB. The advertisement image information DB includes an image ID 17010, an image file 17020, a destination mail address 17030, and a registered date and time 17040.

Next, in step 16070, after an advertisement image ID is set in a record of the advertisement displaying method, the advertisement management server transmits the advertisement displaying method and the advertisement image to the advertisement displaying apparatus in step 16080. The advertisement displaying apparatus displays the advertisement screen as shown in FIG. 13 in accordance with the flow of FIG. 12. It is to be noted that the advertisement image information registering method in FIG. 16 is independent of the advertisement displaying method registering process. Therefore, the user is allowed to register and display different advertisement images at arbitrary timing, under the same displaying condition, by repeatedly executing the advertisement image information registering process as shown in FIG. 16.

According to the present embodiment, it is possible to repeatedly execute the advertisement image information registering process and the advertisement displaying method registering process independently. Therefore, a user is allowed to register multiple advertisements, and register those advertisement images and advertisement displaying methods at different timing. Furthermore, the user is allowed to repeatedly update an advertisement image of a particular advertisement, just by transmitting an E-mail with an image attached thereto. In addition, the advertisement management server which has received the advertisement image is allowed to reliably associate the advertisement image displaying method with the advertisement image.

What is claimed is:

1. A method of registering contents from a terminal to a server via a network, comprising,
a processing method transmitting step of transmitting a processing method for said contents from said terminal to said server,
an E-mail address transmitting step of transmitting from said server to said terminal, an E-mail address associated with said processing method thus transmitted,
a contents transmitting step of transmitting said contents from said terminal to said E-mail address thus transmitted, and
a contents processing step of receiving at said server said contents thus transmitted to said E-mail address and processes the contents based on said processing method thus transmitted.

2. The method according to claim 1 further comprising,
an allocating step of allocating at said server, said E-mail address for each of said processing method, when said server receives said processing method.

3. The method according to claim 1 further comprising,
an allocating step of allocating at said server, said E-mail address for each of a user of said terminal, when said server receives said processing method.

4. The method according to claim 1, wherein,
said processing method is at least one of a displaying condition, a manipulating condition, and a processing condition of said contents.

5. The method according to claim 1 further comprising,
a deciding step of deciding which contents is to be processed when there are multiple number of said contents to be processed, based on at least any of transmitting time, receiving time and a receiving order.

6. The method according to claim 1 further comprising,
an identifier providing step of providing an identifier to said processing method thus received,
an identifier providing step of providing an identifier to said contents thus received, and
an identifier transmitting step of transmitting said identifier from said terminal to said server, wherein,
said contents processing step is the step of processing the contents having said identifier corresponding to said identifier being transmitted, based on the processing method having said identifier corresponding to said identifier being transmitted.

7. A method of registering contents from a terminal to a server via a network comprising,
a processing method transmitting step of transmitting a processing method for said contents from said terminal to a predetermined E-mail address,
a contents transmitting step of transmitting said contents from said terminal to a predetermined E-mail address, and
a processing step of processing at said server, based on said processing method that is received by said server, said contents having said predetermined E-mail address as a destination, which corresponds to said predetermined E-mail address as a destination of the processing method.

8. The method according to claim 7 further comprising,
an E-mail address allocating step of allocating said predetermined E-mail address at said server, when said server receives said processing method, and
an E-mail address transmitting step of transmitting said predetermined E-mail address thus allocated from said server to said terminal.

9. A method of registering contents from a terminal to a server via a network, comprising,
a contents transmitting step of transmitting said contents from said terminal to said server by an E-mail,
a processing method transmitting step of transmitting a processing method for said contents from said terminal to said server by an E-mail, and
a processing step of processing at said server, based on said processing method that is received by said server, said contents having said E-mail address as a sending end, which corresponds to said E-mail address as a sending end of the processing method.

10. An apparatus which processes contents whose registration is accepted from a terminal via a network, comprising,
a processing method receiving module which receives a processing method for said contents from said terminal,
an E-mail address transmitting module which transmits to said terminal an E-mail address associated with said processing method thus received,
a contents receiving module which receives said contents transmitted from said terminal to said E-mail address, and
a contents processing module which processes said contents thus received based on said processing method thus received.

11. The apparatus according to claim 10, further comprising,
an E-mail address allocating module which allocates said E-mail address for each of said processing method, when said processing method receiving module has received said processing method.

12. The apparatus according to claim 10, further comprising,
an E-mail address allocating module which allocates said E-mail address for each of said user of said terminal, when said processing method receiving module has received said processing method.

13. The apparatus according to claim 10, wherein,
said processing method is at least one of a displaying condition, a manipulating condition, and a processing condition of said contents.

14. The apparatus according to claim 10 further comprising,
a deciding module which decides which contents is to be processed when there are multiple number of said contents to be processed, based on at least any of transmitting time, receiving time and a receiving order.

15. The apparatus according to claim 10 further comprising,
an identifier providing module which provides an identifier to said processing method thus received,
an identifier providing module which provides an identifier to said contents thus received, and
an identifier transmitting module which transmits said identifier from said terminal to said server, wherein,
said contents processing module processes the contents having said identifier corresponding to said identifier received, based on the processing method having said identifier corresponding to said identifier received.

16. An apparatus which processes contents whose registration is accepted from a terminal via a network, comprising,
a processing method receiving module which receives a processing method for said contents having a predetermined E-mail address as a destination,
a contents receiving module which receives said contents having a predetermined E-mail address as a destination, and
a processing module which processes, based on said processing method thus received, said contents having said predetermined E-mail address as a destination, which corresponds to said predetermine E-mail address as a destination of said processing method.

17. The apparatus according to claim 16, further comprising,
an E-mail address allocating step which allocates said predetermined E-mail address when said processing method receiving module receives said processing method, and
an E-mail address transmitting module which transmits to said terminal said predetermined E-mail address thus allocated.

18. An apparatus which processes contents whose registration is accepted from a terminal via a network, comprising,
a contents receiving module which receives said contents by an E-mail from said terminal,
a processing method receiving module which receives a processing method for said contents by an E-mail, and
a processing module which processes, based on said processing method thus received, said contents having the E-mail address as a sending end which corresponds to the E-mail address as a sending end of the processing method.
